(19) United States
(12) Patent Application Publication
(10) Pub. No.: US 2026/0364455 A1
(43) Pub. Date: Nov. 19, 2026

(54) METHOD AND APPARATUS FOR VIRTUAL CHARACTER SKILL CASTING, DEVICE, AND STORAGE MEDIUM

(71) Applicant: Tencent Technology (Shenzhen) Company Limited, Shenzhen (CN)

(72) Inventor: Yusheng MAO, Shenzhen (CN)

(21) Appl. No.: 19/735,346

(22) Filed: Jul. 8, 2026

Related U.S. Application Data
(63) Continuation of application No. PCT/CN2025/121240, filed on Sep. 15, 2025.

(30) Foreign Application Priority Data
Oct. 17, 2024 (CN) 202411457966.8

(51) Int. Cl. A63F 13/537; A63F 13/2145

(52) U.S. Cl. CPC A63F 13/537; A63F 13/2145

(57) ABSTRACT

A method for controlling a virtual character to cast a virtual skill is performed by a computer device. The method includes: displaying a graphical user interface including a first virtual character located in a three-dimensional virtual environment and an aiming-type skill control located on a touch layer of the graphical user interface, wherein a plane in which the touch layer is located is different from a horizontal plane in the three-dimensional virtual environment; detecting a drag operation on the aiming-type skill control; when an end position of the drag operation on the aiming-type skill control is located in a first region of the touch layer, casting the virtual skill on the first virtual character; and displaying, on the graphical user interface, a skill effect of the virtual skill on the first virtual character in the three-dimensional virtual environment. The method helps improve human-computer interaction efficiency.

### CROSS-REFERENCE TO RELATED APPLICATIONS

This application is a continuation application of PCT Patent Application No. PCT/CN2025/121240, entitled “METHOD AND APPARATUS FOR VIRTUAL CHARACTER SKILL CASTING, DEVICE, AND STORAGE MEDIUM” filed on Sep. 15, 2025, which claims priority to Chinese Patent Application No. 202411457966.8, entitled “METHOD AND APPARATUS FOR VIRTUAL CHARACTER SKILL CASTING, DEVICE, AND STORAGE MEDIUM” filed on Oct. 17, 2024, both of which are incorporated by reference in their entirety.

### FIELD OF THE TECHNOLOGY

Embodiments of this application relate to the field of computer technologies, and in particular, to a method and an apparatus for virtual character skill casting, a device, and a storage medium.

### BACKGROUND OF THE DISCLOSURE

With the continuous development of computer technologies, there are more types of applications supporting virtual environments. A terminal device can display virtual characters and skill controls in these applications.

When a virtual skill acts on a virtual character controlled by a user, a typical skill casting process of the virtual character is as follows: after the user triggers a skill control, an aiming region displayed in a three-dimensional virtual environment is dragged away from a current position of the virtual character for a specific distance (so that the terminal device recognizes the drag operation), and then the aiming region is dragged back to the current position of the virtual character, to cast the virtual skill on the virtual character controlled by the user.

When being dragged back to the current position of the virtual character, the aiming region needs to be aligned with the current position of the virtual character to cast the virtual skill on the virtual character controlled by the user. The small size of the virtual character and the low precision of the drag operation may prevent the virtual skill from being accurately cast on the virtual character controlled by the user.

### SUMMARY

Embodiments of this application provide a method and an apparatus for virtual character skill casting, a device, and a storage medium, to improve human-computer interaction efficiency. The technical solutions are as follows:

According to one aspect, an embodiment of this application provides a method for controlling a virtual character to cast a virtual skill performed by a computer device, and the method including:
displaying a graphical user interface including a first virtual character located in a three-dimensional virtual environment and an aiming-type skill control located on a touch layer of the graphical user interface, wherein a plane in which the touch layer is located is different from a horizontal plane in the three-dimensional virtual environment;
detecting a drag operation on the aiming-type skill control;
when an end position of the drag operation on the aiming-type skill control is located in a first region of the touch layer, casting the virtual skill on the first virtual character; and
displaying, on the graphical user interface, a skill effect of the virtual skill on the first virtual character in the three-dimensional virtual environment.

According to another aspect, an embodiment of this application provides a computer device. The computer device includes a processor and a memory, the memory storing at least one computer program, and the at least one computer program being loaded and executed by the processor, so that the computer device implements the foregoing method for controlling a virtual character to cast a virtual skill.

According to another aspect, an embodiment of this application provides a non-transitory computer-readable storage medium, the non-volatile computer-readable storage medium storing at least one computer program, and the at least one computer program being loaded and executed by a processor, so that a computer implements the foregoing method for controlling a virtual character to cast a virtual skill.

In this application, the first region dedicated to casting the virtual skill on the first virtual character is arranged on the touch layer, so that an interaction subject can accurately cast the virtual skill on the first virtual character simply by controlling the end position of the drag operation to fall in the first region, thereby improving the accuracy and efficiency of casting the virtual skill on the first virtual character. In addition, since the drag operation ends upon touch release, in this application, the virtual skill can be accurately cast on the first virtual character by performing a drag operation in the touch layer and stopping the touch in the first region of the touch layer. The interaction subject can cast the virtual skill on the first virtual character without complex interaction operations, thereby reducing the cost of learning interaction operations, improving the usability of interaction, and improving human-computer interaction efficiency.

### BRIEF DESCRIPTION OF THE DRAWINGS

FIG. 1 is a schematic diagram of a touch layer according to an embodiment of this application;

FIG. 2 is a schematic diagram of an interaction interface according to an embodiment of this application;

FIG. 3 is a schematic diagram of an aiming-type skill control after being tapped according to an embodiment of this application;

FIG. 4 is a schematic structural diagram of a computer system according to an embodiment of this application;

FIG. 5 is a flowchart of a method for virtual character skill casting according to an embodiment of this application;

FIG. 6 is a schematic diagram of an aiming-type skill control after being triggered according to an embodiment of this application;

FIG. 7 is a schematic diagram of a first region according to an embodiment of this application;

FIG. 8 is a schematic diagram of a second region according to an embodiment of this application;

FIG. 9 is a schematic diagram of a first region and a second region according to an embodiment of this application;

FIG. 10 is a schematic diagram of a first region and a second region according to an embodiment of this application;

FIG. 11 is a schematic diagram of a reference distance between a wheel region and a first region according to an embodiment of this application;

FIG. 12 is a schematic diagram of a first region according to an embodiment of this application;

FIG. 13 is a schematic diagram of a first region and a second region according to an embodiment of this application;

FIG. 14 is a schematic diagram of a fourth region according to an embodiment of this application;

FIG. 15 is an overall flowchart of a method for virtual character skill casting according to an embodiment of this application;

FIG. 16 is a schematic structural diagram of an apparatus for virtual character skill casting according to an embodiment of this application;

FIG. 17 is a schematic structural diagram of a server according to an embodiment of this application; and

FIG. 18 is a schematic structural diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and so on in this application are intended to distinguish similar objects but do not necessarily indicate a specific order or sequence. Data used in such a way is interchangeable in a proper case, so that the embodiments of this application described herein can be implemented, for example, in a sequence other than the sequence illustrated or described herein. The implementations described in the following exemplary embodiments do not represent all implementations consistent with this application. On the contrary, the implementations are merely examples of apparatuses and methods that are described in detail in the appended claims and that are consistent with some aspects of this application.

First, terms involved in the embodiments of this application are briefly described.

A three-dimensional virtual environment refers to a simulated three-dimensional space created using computer technologies. In this environment, an interaction subject may interact with a virtual character in the three-dimensional virtual environment by using various input devices (such as a keyboard, a mouse, a touchscreen, a handle, a motion capture system, or a virtual reality helmet). A virtual environment is usually highly immersive, and can simulate visual, auditory, and even tactile experience in the real world. The three-dimensional virtual environment allows an interaction subject to explore complex worlds, perform tasks, and solve puzzles. Realistic scenes, characters, and storylines are created by using a three-dimensional technology, thereby greatly improving the appeal of interaction and the engagement of the interaction subject. In some embodiments, the three-dimensional virtual environment may also be referred to as a three-dimensional virtual scene, a three-dimensional virtual world, or the like. The interaction subject may also be referred to as a user, a player, or the like.

A virtual character refers to an active character in a three-dimensional virtual environment. The active character may be at least one of a virtual person, a virtual animal, or an animation character. A virtual character may be a three-dimensional model in a three-dimensional virtual environment. Each virtual character has its shape and volume in a three-dimensional virtual world, and occupies a part of space in the three-dimensional virtual environment. In some embodiments, a virtual character is a three-dimensional character constructed based on a three-dimensional human skeleton technology, and the virtual character achieves different external appearances by wearing different skins.

A touch layer refers to a layer on a touchscreen device, and may be considered as a detector for touch events triggered by an interaction subject on an interaction interface. The touch layer is located at an uppermost layer of the interaction interface, is not in a same horizontal plane as the three-dimensional virtual environment, and is configured to process a touch input of the interaction subject. On the touchscreen device, the touch layer is a first contact point for interaction between the interaction subject and the three-dimensional virtual environment. The touch layer typically includes touchable elements such as a button, a slider, a virtual joystick, and a control. When a touch event occurs (for example, a finger of an interaction subject touches or drags), the touch layer detects the touch event, converts data into a recognizable operation signal, and triggers corresponding interaction control logic, such as movement of a virtual character or casting of a virtual skill.

A dual-joystick mode is a game operation mode specifically designed on a terminal device. The dual-joystick mode simulates two analog joysticks on a conventional gamepad, to control the movement and viewing angle/aiming of a virtual character in a game, respectively. This is implemented by using two virtual joysticks at fixed positions on the touch layer. A left joystick portion is responsible for controlling forward movement, backward movement, left turn, and right turn of the virtual character, and a right joystick portion is responsible for controlling viewing angle turning of the virtual character. The joystick portion mentioned in this application refers to the right joystick portion.

The aiming-type skill control is an interaction element displayed on the touch layer for indicating a direction and a casting region of an aiming-type skill, and is a trigger control for a virtual skill that requires precise aiming at an aiming region during interaction.

The aiming-type skill control includes a joystick portion. The joystick portion and a wheel region in which the joystick portion can be dragged are displayed on the touch layer in response to a trigger operation for the aiming-type skill control. For example, the wheel region is a region centered on a center point of the aiming-type skill control. The size of the wheel region may be set based on experience, or may be flexibly adjusted based on application scenarios or requirements. This is not limited in the embodiments of this application. For example, an initial display position of the joystick portion is centered on the center point of the aiming-type skill control. The size of the joystick portion may be set based on experience, or may be flexibly adjusted based on application scenarios or requirements. This is not limited in the embodiments of this application. The drag operation may achieve an effect as follows: in response to the drag operation on the joystick portion, movement of the joystick portion within the wheel region is displayed according to a drag direction and a drag distance of the drag operation.

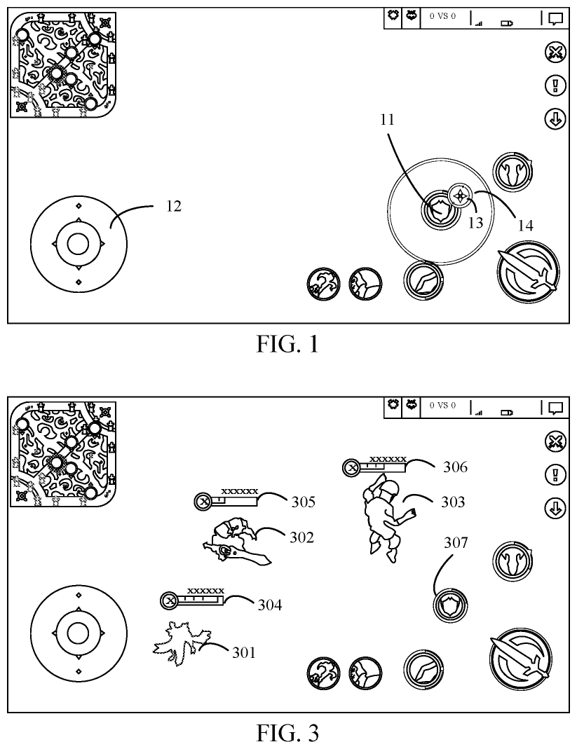

FIG. 1 is a schematic diagram of a touch layer, in which an aiming-type skill control 11 and a left joystick portion 12 are displayed. In response to a trigger operation for the aiming-type skill control 11, a right joystick portion 13 is displayed, and the right joystick portion 13 can be dragged within the range of a wheel region 14.

The implementation of the aiming-type skill control includes, but is not limited to, a button, an icon, a gesture recognition prompt, a keyboard combination, or a particular key on a gamepad. When the aiming-type skill control is displayed as an icon, a display position of the skill icon includes, but is not limited to, a skill bar located at the bottom or on a side of the touch layer. After the aiming-type skill control is triggered, an aiming region is displayed in the three-dimensional virtual environment. The aiming region is displayed in at least one of the following forms: a circle, a line segment, a three-point star, a hexagon, and a circular sector.

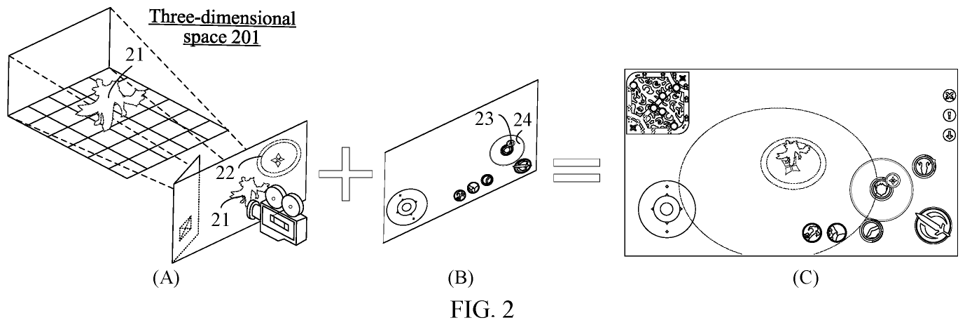

This application is described by using a circular aiming region as an example. The aiming region described below is by default a circular aiming region. Referring to FIG. 2, which is a schematic diagram of an interaction interface, a camera captures a view in a three-dimensional virtual environment, and the view of the three-dimensional virtual environment is displayed in part A of FIG. 2 (a plane in which the three-dimensional virtual environment is located). The three-dimensional virtual environment includes a virtual character 21 and an aiming region 22. The view displayed in a plane in which the touch layer is located as illustrated in FIG. 1 is displayed in part B of FIG. 2 (the plane in which the touch layer is located). When an interaction subject drags a right joystick portion 23 within a wheel region 24, the aiming region 22 in the three-dimensional virtual environment moves accordingly. When the aiming region 22 is positioned at the feet of the virtual character in the three-dimensional virtual environment, it is determined that the virtual character is aimed at. The view of the interaction interface related to this application as shown in part C of FIG. 2 is obtained by combining the view of the three-dimensional virtual environment in part A of FIG. 2 and the view of the touch layer displayed in part B of FIG. 2.

The following describes triggering manners of the aiming-type skill control in this application.

### Manner 1: Tap

A tap operation may be an operation of pressing the aiming-type skill control perpendicularly on a display screen without performing sliding, dragging or other operations on the display screen, and then lifting the finger perpendicularly off the display screen. Virtual skills corresponding to tapping the aiming-type skill control include, but are not limited to, a virtual skill that does not require selection of a casting target, a virtual skill that does not require selection of a casting position, a virtual skill that does not require selection of a casting direction, and a virtual skill for which a system automatically selects a target, a casting position, or a casting direction according to autonomous selection logic. Such virtual skills include, for example, increasing an attack speed of a first virtual character controlled by the interaction subject, or increasing health points of the first virtual character controlled by the interaction subject.

After the aiming-type skill control is tapped, a casting manner of the virtual skill includes, but is not limited to, casting the virtual skill on a virtual character with a lowest attribute value (i.e., health points) within a casting range of the virtual skill. For example, the casting range is a range within which the virtual skill can produce an effect after being cast. For example, the effect produced by the virtual skill may include a buff effect or a negative effect (also referred to as an attack effect). The buff effect may include, but is not limited to: increasing an attribute value, increasing a movement speed, defending against an attack, and the like. The negative effect may include, but is not limited to: launching an attack, reducing a movement speed, reducing an attribute value, and the like.

For example, the attribute value of the virtual character may be displayed by using an attribute bar, or may be displayed by using a numerical value.

FIG. 3 is a schematic diagram of an aiming-type skill control after being tapped, FIG. 3 shows a first virtual character 301 controlled by an interaction subject, another virtual character 302 controlled by another interaction subject, and further another virtual character 303 controlled by further another interaction subject. An attribute value corresponding to the first virtual character 301 is an attribute value displayed in an attribute bar 304, an attribute value corresponding to the another virtual character 302 is an attribute value displayed in an attribute bar 305, and an attribute value corresponding to the further another virtual character 303 is an attribute value displayed in an attribute bar 306. An aiming-type skill control 307 is displayed at the lower right corner, and in response to a tap operation on the aiming-type skill control 307, a virtual skill is automatically cast on the virtual character 302 currently having the lowest attribute value.

For example, after the aiming-type skill control is tapped, the casting manner of the virtual skill may further include: casting the virtual skill on a virtual character having a highest attribute value within a casting range of the virtual skill, casting the virtual skill on a virtual character in a same camp as the first virtual character controlled by the interaction subject within the casting range of the virtual skill, casting the virtual skill on a virtual character in a different camp from the first virtual character controlled by the interaction subject within the casting range of the virtual skill, and the like.

### Manner 2: Drag

A drag operation may be a behavior manner in which an interaction subject controls a finger to slide or drag a specific distance parallel to a display interface and then lifts the finger. Virtual skills cast through the drag operation include, but are not limited to, virtual skills requiring selection of a casting direction, for example, selecting to cast the virtual skill toward the upper left of the display screen after triggering the drag operation and before casting the virtual skill; or virtual skills requiring selection of a casting position, for example, selecting the position of virtual character A to cast the virtual skill after triggering the drag operation and before casting the virtual skill, i.e., casting the virtual skill toward an enemy during interaction, or selecting the position of the first virtual character controlled by the interaction subject to cast the virtual skill, i.e., casting the virtual skill toward the first virtual character during interaction.

In a related technology, an interaction subject needs to control an aiming region in a three-dimensional virtual environment by using an aiming-type skill control on a touch layer. Due to a small size of a virtual character, the process of aligning the aiming region with the virtual character has low operational precision. In addition, it is necessary to drag the aiming region outward by a specific distance starting from a current position of the virtual character, and then drag the aiming region back to the current position of the virtual character. This operation process is cumbersome for the interaction subject.

To further describe the technical solutions provided in the embodiments of this application, a detailed description is given below with reference to the accompanying drawings and specific implementations. Although the embodiments of this application provide method operation steps shown in the following embodiments or accompanying drawings, more or fewer operation steps may be included in the method based on conventional technology or without creative efforts. In steps where there is no logically necessary causal relationship, an execution sequence of the steps is not limited to the execution sequence provided in the embodiments of this application. During actual processing of the method or when the method is performed by a control device, the method may be performed according to a method sequence shown in the embodiments or the accompanying drawings or may be performed in parallel.

Other features and advantages of this application will be described in the following specification, and, in part, will become apparent from the specification, or may be learned by practice of this application. The objectives and other advantages of this application may be implemented and obtained by using structures particularly indicated in the written specification, claims, and accompanying drawings.

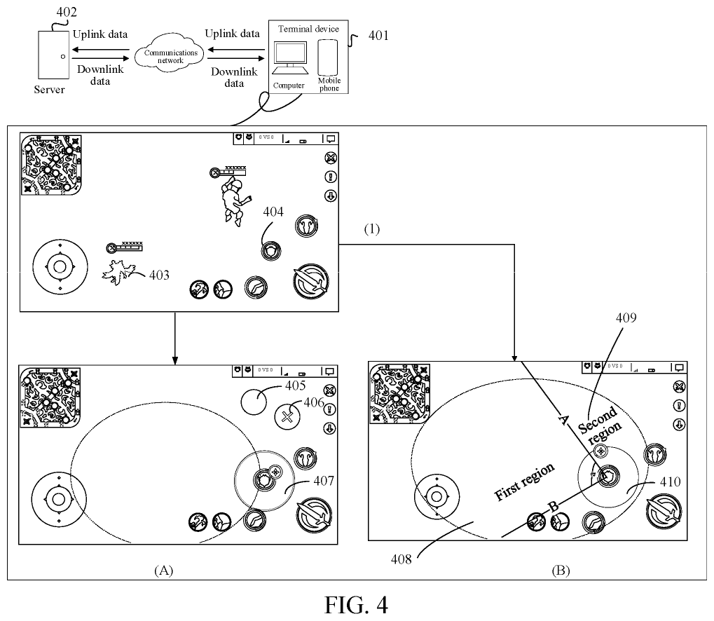

FIG. 4 is a schematic structural diagram of a computer system according to an embodiment of this application. The computer system includes a terminal device 401 and a server 402. The terminal device 401 is a terminal device used by an interaction subject. A game client capable of providing a real-time battle interface is installed and run on the terminal device 401. The method for virtual character skill casting provided in this embodiment of this application may be executed by the terminal device 401 alone, or jointly executed by the terminal device 401 and the server 402. This is not limited in the embodiments of this application.

An application supporting a virtual environment is installed and run on the terminal device 401. An interaction subject can control, by using the terminal device 401, a first virtual character to perform activities in the virtual environment provided by the application, to implement an interaction process between the interaction subject and the terminal device 401 based on the first virtual character. The activities include, but are not limited to: adjusting a body posture, crawling, walking, running, riding, jumping, driving, picking, shooting, attacking another virtual character, throwing, changing a position, and the like.

The application that supports a virtual environment is not limited in the embodiments of this application. For example, the application that supports a virtual environment includes, but is not limited to: a virtual reality (VR) application, an augmented reality (AR) application, a three-dimensional map program, a game application, a social application, an interactive entertainment application, and the like. For example, the game application includes, but is not limited to: a Multiplayer Online Battle Arena (MOBA) game, an open world game, or a Massive Multiplayer Online Game (MMOG). In some embodiments, the application may also be referred to as a client.

In some embodiments, the application supporting a virtual environment may support at least one operating system, and applications running on different operating systems are interoperable. In some embodiments, the application supporting a virtual environment is an application developed based on a three-dimensional engine. In some embodiments, the application supporting a virtual environment is a stand-alone application or a network-online application.

The server 402 is configured to provide a background service for the application that supports the virtual environment and that is installed on the terminal device 401. In an implementation, the server 402 undertakes primary computing work, and the terminal device 401 undertakes secondary computing work. Alternatively, the server 402 undertakes secondary computing work, and the terminal device 401 undertakes primary computing work. Alternatively, the server 402 and the terminal device 401 perform collaborative computing by using a distributed computing architecture.

In one implementation, the terminal device 401 is any electronic product that can perform human-computer interaction with an interaction subject by using one or more methods such as a keyboard, a touchpad, a touchscreen, a remote control, a gamepad, voice interaction, or a handwriting device. For example, the terminal device 401 may be, but is not limited to, a personal computer (PC), a mobile phone, a smartphone, a personal digital assistant (PDA), a wearable device, a handheld portable game device, a pocket PC (PPC), a tablet computer, a notebook computer, a desktop computer, a smart on-board unit, a smart television, a smart speaker, a smartwatch, or an in-vehicle terminal.

The server 402 may be an independent physical server, or a server cluster or distributed system including a plurality of physical servers, or a cloud server providing basic cloud computing services such as a cloud service, a cloud database, cloud computing, a cloud function, cloud storage, a network service, cloud communication, a middleware service, a domain name service, a security service, a Content Delivery Network (CDN), big data, and an artificial intelligence platform. This is not limited in the embodiments of this application. The server 402 and the terminal device 401 are directly or indirectly connected in a wired communication manner or a wireless communication manner. This is not limited in this application. The server 402 has a data receiving function, a data processing function, and a data transmitting function. Certainly, the server 402 may also have other functions, which are not limited in the embodiments of this application.

The terminal device 401 may refer to one of a plurality of terminal devices. In this embodiment, only the terminal device 401 is used as an example for description. A person skilled in the art may understand that there may be more or fewer terminal devices 401. For example, there may be only one terminal device 401, or there may be dozens or hundreds of terminal devices 401, or more. A quantity and device types of the terminal devices 401 are not limited in the embodiments of this application.

The method for virtual character skill casting provided in the embodiments of this application may be performed by the terminal device 401, or may be performed by the server 402, or may be performed interactively by the terminal device 401 and the server 402. This is not limited in the embodiments of this application. In some embodiments, the terminal device 401 transmits uplink data to the server 402 by using the method for virtual character skill casting provided in the embodiments of this application. The uplink data includes at least one of a request for casting a virtual skill on a first virtual character or a result of casting a virtual skill on a first virtual character. The server 402 performs validity verification on the uplink data transmitted by the terminal device 401, and transmits downlink data to the terminal device 401. The downlink data includes data that has passed the validity verification from the terminal device 401 and other terminal devices.

For example, as shown in FIG. 4, the terminal device 401 may perform the method for virtual character skill casting provided in the embodiments of this application based on the following process. Referring to part (1) of FIG. 4, the terminal device 401 displays a first virtual character 403 located in a three-dimensional virtual environment and an aiming-type skill control 404 located on a touch layer. The aiming-type skill control 404 is configured to cast, after being triggered, a virtual skill of the first virtual character toward an aiming region. Referring to part A of FIG. 4, a first region 405 is displayed on the touch layer in the display interface of the terminal device 401. The first region 405 has no intersection with a second region 406, and the second region 406 is a region on the touch layer for canceling skill casting. The first region 405 has no intersection with a third region 407, and the third region 407 is a common landing region for the aiming-type skill control. The common landing region is determined based on landing positions of drag operations when the virtual skill is cast on virtual characters other than the first virtual character. The first region 405 is a region at a reference distance outside the third region 407. The virtual skill is cast toward a reference position of the first virtual character in the three-dimensional virtual environment when an end position of a drag operation on the aiming-type skill control is located in the first region of the touch layer, a drag distance of the drag operation is greater than a second distance threshold, the drag distance of the drag operation is greater than a first distance threshold, and an operation duration of the drag operation is less than a duration threshold. The first distance threshold is a distance threshold for determining whether to cancel skill casting, and the second distance threshold is a distance threshold for determining whether a current operation is the drag operation or a tap operation. The reference position is a position of the first virtual character in the three-dimensional virtual environment after a buffer duration elapses upon completion of the drag operation. The buffer duration is a duration in which the virtual skill is buffered from a first state to a second state. The first state is a triggered state of the virtual skill upon completion of the drag operation. The second state is a cast state of the virtual skill. A skill effect of the virtual skill on the first virtual character is displayed in the three-dimensional virtual environment.

Due to different display styles of the first region, in part B of FIG. 4, a first region 408 of another style is displayed on the touch layer in the display interface of the terminal device 401. The first region 408 has no intersection with a second region 409, and the second region 409 is a region on the touch layer for canceling skill casting. The first region 408 has no intersection with a third region 410, and the third region 410 is a common landing region for the aiming-type skill control. The common landing region is determined based on landing positions of drag operations when the virtual skill is cast on virtual characters other than the first virtual character. The first region 408 is a region at a reference distance outside the third region 410. The virtual skill is cast toward a reference position of the first virtual character in the three-dimensional virtual environment when an end position of a drag operation on the aiming-type skill control is located in the first region of the touch layer, a drag distance of the drag operation is greater than a second distance threshold, the drag distance of the drag operation is greater than a first distance threshold, and an operation duration of the drag operation is less than a duration threshold. The first distance threshold is a distance threshold for determining whether to cancel skill casting, and the second distance threshold is a distance threshold for determining whether a current operation is the drag operation or a tap operation. The reference position is a position of the first virtual character in the three-dimensional virtual environment after a buffer duration elapses upon completion of the drag operation. The buffer duration is a duration in which the virtual skill is buffered from a first state to a second state. The first state is a triggered state of the virtual skill upon completion of the drag operation. The second state is a cast state of the virtual skill. A skill effect of the virtual skill on the first virtual character is displayed in the three-dimensional virtual environment.

A person skilled in the art should understand that the terminal device 401 and the server 402 are merely examples for description, and other terminal devices or servers that are in the related technology or that may appear in the future, if applicable to this application, shall also fall within the protection scope of this application, and are incorporated herein by reference.

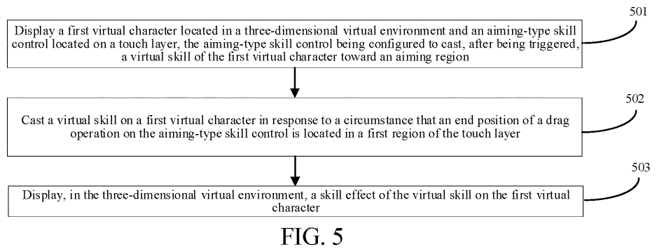

Based on the computer system shown in FIG. 4, an embodiment of this application provides a method for virtual character skill casting. The method may be executed by the terminal device 401, or may be executed by the server 402, or may be implemented interactively by the terminal device 401 and the server 402. This is not limited in this embodiment of this application. In other words, the method for virtual character skill casting provided in this embodiment of this application may be executed by a computer device, and the computer device may be a terminal device or a server. This embodiment of this application is described by using an example in which the method for virtual character skill casting is performed by a terminal device. As shown in FIG. 5, the method for virtual character skill casting provided in this embodiment of this application may include the following operation 501 to operation 503.
Operation 501: Display a first virtual character located in a three-dimensional virtual environment and an aiming-type skill control located on a touch layer, the aiming-type skill control being configured to cast, after being triggered, a virtual skill of the first virtual character toward an aiming region. In some embodiments, the computer device displays a graphical user interface including a first virtual character located in a three-dimensional virtual environment and an aiming-type skill control located on a touch layer of the graphical user interface. A plane in which the touch layer is located is different from a horizontal plane in the three-dimensional virtual environment.

A plane in which the touch layer is located is different from a horizontal plane in the three-dimensional virtual environment. In other words, the plane in which the touch layer is located is misaligned with the horizontal plane in the three-dimensional virtual environment. Under such arrangement, the plane in which the touch layer is located can be visually distinguished from the horizontal plane in the three-dimensional virtual environment, to clearly distinguish an operation performed on the plane in which the touch layer is located from an operation performed on the horizontal plane in the three-dimensional virtual environment, thereby reducing operation conflicts, improving operation precision, and further improving human-computer interaction efficiency. The horizontal plane in the three-dimensional virtual environment is a two-dimensional plane that is perpendicular to the direction of gravity in the three-dimensional virtual environment.

The first virtual character is an active character in the three-dimensional virtual environment controlled by an interaction subject by using a terminal device. The first virtual character may be a virtual person, a virtual animal, an animation character, or the like. The interaction subject may control the virtual character by using a peripheral component or by tapping on a touch display screen.

The aiming region is a virtual region, in which the interaction subject expects to cast a virtual skill, pre-aimed by the interaction subject in the three-dimensional virtual environment. For example, the purpose of casting the virtual skill may include attacking, and the aiming region is a virtual region, to which the interaction subject expects to launch an attack, pre-aimed by the interaction subject in the three-dimensional virtual environment. In some embodiments, the virtual skill may also be referred to as a virtual aiming-type skill. For example, when the interaction subject aims in advance at a region A in which a virtual character A is located, after the aiming-type skill control is triggered, the virtual aiming-type skill launches an attack to the region A in which the virtual character A is currently located. Alternatively, when the interaction subject aims in advance at a region B in which the first virtual character controlled by the interaction subject is located, after the aiming-type skill control is triggered, the virtual aiming-type skill launches an attack to the region B in which the first virtual character controlled by the interaction subject is currently located.

A virtual skill is a functional element set for increasing interactivity and depth of an interaction process. A virtual skill endows a virtual character with special capabilities, such as enhanced attack power, improved defense capability, health recovery, and enemy control. Virtual skills can be classified into two categories: passive skills and active skills. A passive skill does not require manual activation by the interaction subject. The passive skill automatically takes effect when conditions are met, as long as the virtual character possesses the passive skill, such as natural health recovery and resistance enhancement. An active skill, such as casting magic and launching melee attacks, needs to be manually activated by the interaction subject through tapping, dragging, key pressing, or the like.

Virtual skills include skills that directly improve attribute values of the first virtual character, or include control skills that affect an interaction rhythm. Virtual skills are classified into attack skills that directly cause damage to enemies, defense skills that reduce damage caused in an interaction process, control skills that affect enemy actions, healing, buffing, auxiliary skills that enhance the overall strength of an interaction team, and passive skills that do not require manual activation and automatically take effect. After the virtual skill of the first virtual character is cast, an attack effect may be generated on another virtual character, or a buff effect may be generated on the first virtual character. A single virtual skill may achieve both effects: when cast on another virtual character, it produces an attack effect on the another virtual character; when cast on the first virtual character, it produces a buff effect on the first virtual character. Alternatively, different virtual skills may be adopted, i.e., the first virtual character has a dedicated virtual skill A to be cast on the first virtual character itself. When cast on the first virtual character, the virtual skill A produces a buff effect on the first virtual character.

The virtual skill involved in this application may produce a buff effect on the first virtual character. Whether the virtual skill causes an attack effect on another virtual character interacting with the first virtual character is not limited in this application. In other words, when the virtual skill is used to generate a buff effect on the first virtual character, the first virtual character needs to be set as a casting target of the virtual skill; when the virtual skill is used to generate a negative effect on another virtual character, the another virtual character needs to be set as a casting target of the virtual skill. Alternatively, configuration that the virtual skill has no effect on other virtual characters and only produces a buff effect on the first virtual character when cast on the first virtual character may be changed.

The quantity of virtual skills possessed by the first virtual character is not limited in this application. The first virtual character may have one or more virtual skills, including but not limited to a virtual skill required by the first virtual character during interaction, a virtual skill initially possessed by the first virtual character, a virtual skill obtained by the first virtual character during interaction, or the like. For example, a manner in which the first virtual character obtains a virtual skill during interaction may include, but is not limited to, completing a task, attacking another virtual character, leveling up, and the like.

Displaying the first virtual character may be displaying, by the terminal device based on a startup operation of an application, the first virtual character in a plane of the three-dimensional virtual environment. A display position of the first virtual character in the plane of the three-dimensional virtual environment is related to a position of the first virtual character in the three-dimensional virtual environment, a position and orientation of a camera for image capture of the three-dimensional virtual environment, and the like.

Displaying the aiming-type skill control may be displaying, by the terminal device based on a startup operation of an application, the aiming-type skill control in a plane in which the touch layer is located. A display position of the aiming-type skill control in the plane of the touch layer may be set based on experience, or may be flexibly adjusted based on application scenarios and requirements. This is not limited in this embodiment of this application. For example, the display position of the aiming-type skill control in the plane of the touch layer may be a lower right corner of the plane of the touch layer, a lower left corner of the plane of the touch layer, or the like.
Operation 502: After detecting a drag operation on the aiming-type skill control, cast the virtual skill on the first virtual character when an end position of the drag operation on the aiming-type skill control is located in a first region of the touch layer.

For the aiming-type skill control, refer to related descriptions above, and details are not described herein again.

A drag operation is typically implemented on a terminal device with a touch function, such as a smartphone or a tablet computer. An interaction subject controls a direction and intensity of a virtual skill by touching and dragging a virtual joystick portion on a screen. When the finger of the interaction subject touches the joystick portion for the first time, the system recognizes the touch point as a starting point of the drag operation. In this case, a preparation phase for skill casting begins, and the interaction subject controls a casting direction of the virtual skill by controlling a movement direction of the finger on the screen. In addition, a drag distance is usually directly proportional to a casting range or intensity of the virtual skill. The interaction subject may adjust the casting range or intensity of the virtual skill by controlling the drag distance of the finger. For the drag operation, refer to the foregoing detailed descriptions, and details are not described herein again. For example, the system may be an operating system in the terminal device, or may be a system for running an application in the operating system of the terminal device.

Ending of the drag operation may be interpreted as the finger of the interaction subject leaving the display screen or returning to a start point of the joystick portion. The end position of the drag operation is a touch position on the display screen when the finger leaves the display screen. The ending manner of the finger leaving the screen is as follows: when the finger of the interaction subject lifts off the display screen, the system determines that the drag operation ends, i.e., the end position is a position mapped to the touch layer from the position where the finger lifts off the display screen. The ending manner of returning to the start point of the joystick portion is as follows: the interaction subject can drag the finger and then slowly move the finger back to the start point of the joystick portion, i.e., the end position is a position mapped to the touch layer from the position of the joystick portion on the display screen. This application does not limit the ending manner of the drag operation.

In an exemplary implementation, the casting the virtual skill on the first virtual character when an end position of a drag operation on the aiming-type skill control is located in a first region of the touch layer includes: casting the virtual skill on the first virtual character when the end position of the drag operation on the aiming-type skill control is located in the first region of the touch layer, and a drag distance of the drag operation is greater than a second distance threshold. The second distance threshold is a distance threshold for determining whether a current operation is the drag operation or a tap operation.

The second distance threshold is set in advance, to clearly distinguish whether a drag operation or a tap operation is initiated, avoiding the problem that an intended tap operation on the aiming-type skill control is recognized as a drag operation due to hand trembling or other factors when the interaction subject triggers the aiming-type skill control, thereby protecting the drag operation and improving the accuracy of tap triggering or drag triggering by the interaction subject based on the aiming-type skill control.

The method for determining the second distance threshold is not limited in this application, including but not limited to: determining the second distance threshold based on human experience; or customizing the second distance threshold based on interaction habits of the interaction subject.

For an operation manner of the drag operation and an operation manner of the tap operation, refer to the foregoing detailed descriptions, and details are not described herein again.

Since the interaction subject is a human, physiological limitations such as hand trembling and slight displacement during lifting after tapping are unavoidable, making it impossible for a tap input to be 100% perpendicular to the display screen. Therefore, an input of the interaction subject always has a certain offset outward from the center of the aiming-type skill control. The method for determining whether the current operation is a drag operation or a tap operation based on the second distance threshold includes, but is not limited to: if the drag distance of the drag operation is less than the second distance threshold, the system considers that the interaction subject intends to perform a tap operation, and determines that the current operation is a tap operation; if the drag distance of the drag operation is greater than or equal to the second distance threshold, the system considers that the interaction subject intends to perform a drag operation, and determines that the current operation is a drag operation.

When the drag distance of the drag operation is greater than the second distance threshold, it may indicate that the interaction subject intends to perform a drag operation on the aiming-type skill control. In this case, if the end position of the drag operation on the aiming-type skill control is located in the first region of the touch layer, the operation of casting the virtual skill on the first virtual character is preferentially performed.

In an exemplary embodiment, after the aiming-type skill control is triggered, the joystick portion and a wheel region in which the joystick portion can be dragged are displayed on the touch layer. The wheel region is in a mapping relationship with an energy acting range of the virtual skill, and the joystick portion is in a mapping relationship with the aiming region in the three-dimensional virtual environment. The aiming region is located within the energy acting range. The energy acting range is a range in which the virtual skill can produce an effect after being cast. In some embodiments, the energy casting range may also be referred to as a casting range. When a drag operation on the joystick portion within the wheel region is detected, the aiming region moves in the energy acting range, simulating the movement of the joystick portion in the wheel region.

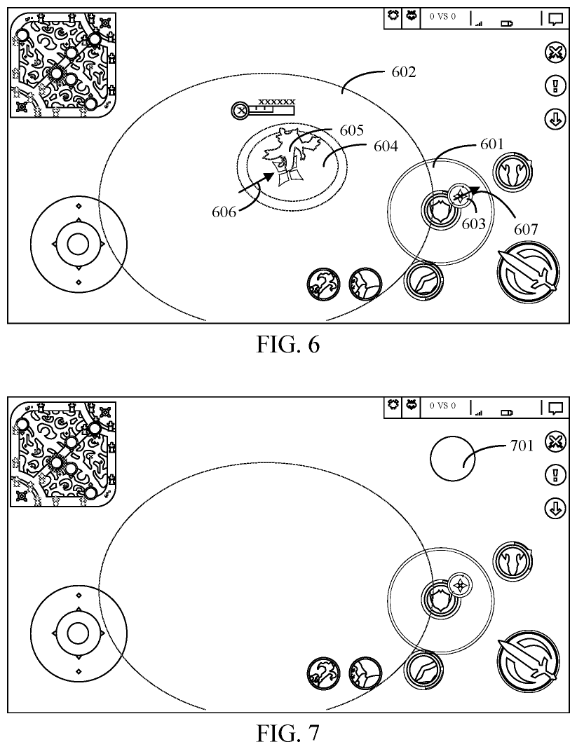

FIG. 6 is a schematic diagram of an aiming-type skill control after being triggered. Since a wheel region 601 is in a mapping relationship with an energy acting range 602 of a virtual skill, and a joystick portion 603 is in a mapping relationship with an aiming region 604 in a three-dimensional virtual environment, in response to a drag operation on the joystick portion 603 within the wheel region 601, the aiming region 604 always moves in a large circle of the energy acting range 602 centered on a virtual character 605, simulating the movement of the joystick portion 603 in the wheel region 601. An arrow 606 in FIG. 6 is the mapping of movement of an arrow 607.

The first region is set on the touch layer. When the end position of the drag operation is within the range of the first region, the virtual skill is cast on the first virtual character, i.e., the first region may be a region dedicated to casting the virtual skill on the first virtual character controlled by the interaction subject.

The display timing of the first region is not limited in this application, and the first region may be continuously displayed from the start of the interaction. Alternatively, the first region is displayed when the drag distance of the drag operation is greater than or equal to a display threshold, i.e., the first region is displayed after the joystick portion is dragged within the wheel region by a distance equal to or greater than the display threshold. Alternatively, the first region is displayed when an attribute value of the first virtual character reaches an attribute threshold during interaction. The display threshold is a numerical value that constrains the drag distance of the drag operation. The display threshold may be set based on experience, or may be flexibly adjusted based on application scenarios or requirements. This is not limited in the embodiments of this application. The attribute threshold is a threshold that constrains the attribute value of the first virtual character. The attribute threshold may be set based on experience, or may be flexibly adjusted based on application scenarios or requirements. This is not limited in the embodiments of this application.

Configuration styles of the first region are described below.
Style 1: In an exemplary implementation, the first region is a region with a regular shape on the touch layer.

A region with a regular shape is set on the touch layer as the first region, so that the interaction subject perceives the range of the first region more intuitively and clearly during interaction. When the virtual skill needs to be cast on the first virtual character, a drag operation can quickly reach a designated position, thereby improving human-computer interaction efficiency.

The region with a regular shape may be an interaction region with a specific shape and boundaries defined on the touch layer. The first region corresponds to a virtual skill that can be cast on the first virtual character controlled by the interaction subject. For example, a circular, rectangular, or elliptical region may be designated as the region for casting the virtual skill on the first virtual character. When the interaction subject performs a drag operation on the display screen, the system detects whether an end position of the operation enters the boundaries of the regular shape and falls within the region of the regular shape. If the end position falls within the region of the regular shape, the virtual skill is cast on the first virtual character. The shape of the first region is not limited in this application, and includes, but is not limited to, a circle, a square, a trapezoid, a rectangle, an ellipse, or the like.

FIG. 7 is a schematic diagram of a first region. A closed circular region displayed on the touch layer is defined as a first region 701.

When the first region is a region with a regular shape, a display style of the region with the regular shape is not limited in this application. For example, prompt information of “cast on first virtual character” may be displayed in the region with the regular shape. Alternatively, a virtual animation representing the first virtual character may be displayed in the region with the regular shape. Alternatively, an attribute box simulating the first virtual character whose attribute value is increased may be displayed in the region with the regular shape.
Style 2: In an exemplary implementation, the first region is a first angle region on the touch layer, and a vertex of the first angle region is determined based on the aiming-type skill control.

The first region is a region within the range of a first angle, and has no clear closed boundaries, thereby expanding a usable area of the first region. During a drag operation, the interaction subject only needs to make the end position of the drag operation stay at any position within the range of the first angle, making it more convenient and accurate to trigger casting of the virtual skill on the first virtual character, thereby improving the efficiency of casting the virtual skill on the first virtual character.

The first angle region is a region defined by a vertex, a first direction boundary line, and a second direction boundary line.

The method for determining the vertex is not limited in this application, including but not limited to, using a center point of an aiming-type wheel region as the vertex. The aiming-type wheel region is a wheel region displayed after the aiming-type skill control is triggered. In some embodiments, the method for determining the vertex may further include using a center point of the aiming-type skill control as the vertex. In some embodiments, the method for determining the vertex may further include using any point on a boundary of the aiming-type skill control as the vertex.

The method for determining the first direction boundary line and the second direction boundary line is not limited in this application, including but not limited to, setting the first direction boundary line and the second direction boundary line based on human experience; or equally dividing a circular wheel region in all directions, and determining the first direction boundary line and the second direction boundary line according to a historical distribution density, where the historical distribution density is a distribution density of end positions of drag operations on the touch layer in historical interaction data; or customizing the first direction boundary line and the second direction boundary line based on interaction habits of the interaction subject.

For example, a range with a historical distribution density greater than or equal to a density threshold is used as a range formed by the first direction boundary line and the second direction boundary line. In other words, by analyzing the historical distribution density, it is determined that the interaction subject habitually ends drag operations in the first angle region, making it more convenient for the interaction subject to locate the end position of the drag operation within the range of the first region represented by the first angle.

The first direction boundary line includes a straight line and a curved line, and the style of the first direction boundary line is not limited in this application. The second direction boundary line includes a straight line and a curved line, and the style of the second direction boundary line is not limited in this application.

The position of the first region on the touch layer is described in detail below.

In an exemplary implementation, the first region has no intersection with the second region, and the second region is a region on the touch layer for canceling skill casting.

The first region is set at a position that has no intersection with the second region. The first region and the second region with different functions are clearly distinguished, thereby reducing confusion of the interaction subject, improving the usability of the touch layer, and reducing the risk of accidental touches. In other words, when the interaction subject intends to cast a virtual skill on the first virtual character, the virtual skill will not be canceled due to misoperation, thereby improving the accuracy of virtual skill casting.

Canceling skill casting may be terminating, by the interaction subject, the casting of a virtual skill through a specific operation during an animation playback or execution process of the virtual skill. The interaction subject may cancel in time, according to changes in the interaction situation, a virtual skill about to be cast, to avoid unnecessary energy consumption or mistakes.

That the first region has no intersection with the second region may be interpreted as that the first region and the second region are completely separated and independent of each other on the touch layer, without any overlapping portion, and an operation by the interaction subject in one region does not affect the other region.

For the first region and the second region, visual prompts may be adopted to enhance the sense of boundary of each region. This application does not limit the style of the second region, which may be the same as the style of the first region, or may be different from the style of the first region. The style of the second region is described below.
Style 1: In an exemplary implementation, the second region is a region with a regular shape on the touch layer.

For the regular shape, refer to the foregoing related descriptions of the first region. Details are not described herein again. This application does not limit the display content within the shape of the second region. For example, prompt information such as “cancel” may be displayed in the region with the regular shape. Alternatively, a cross mark indicating cancellation may be displayed in the region with the regular shape. Alternatively, an animation simulating cancellation of virtual skill casting may be displayed in the region with the regular shape.

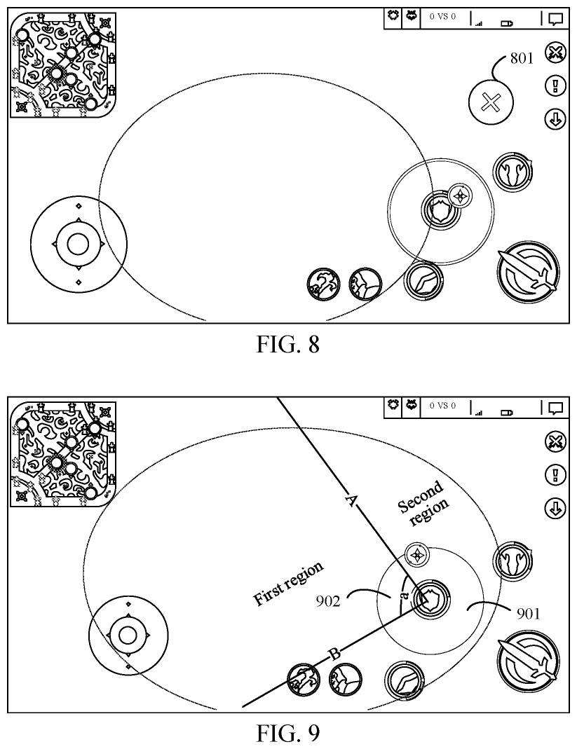

FIG. 8 is a schematic diagram of a second region. A circular region 801 with a cross mark represents the second region for canceling virtual skill casting.
Style 2: In an exemplary implementation, the second region is a second angle region on the touch layer, and a vertex of the second angle region is determined based on the aiming-type skill control.

The second angle region is a region defined by a vertex, a third direction boundary line, and a fourth direction boundary line. The method for determining the vertex is not limited in this application, including but not limited to, using a center point of the aiming-type wheel region as the vertex, using a center point of the aiming-type skill control as the vertex, using any point on the boundary of the aiming-type skill control as the vertex, and the like. In some embodiments, the vertex of the second angle region is the same as the vertex of the first angle region. In some other embodiments, the vertex of the second angle region is different from the vertex of the first angle region.

The method for determining the third direction boundary line and the fourth direction boundary line is not limited in this application, including but not limited to, setting the third direction boundary line and the fourth direction boundary line based on human experience; or equally dividing a circular wheel region in all directions, and determining the third direction boundary line and the fourth direction boundary line according to a historical distribution density, where the historical distribution density is a distribution density of end positions of drag operations on the touch layer in historical interaction data; or customizing the third direction boundary line and the fourth direction boundary line based on interaction habits of the interaction subject.

For example, a range with a historical distribution density greater than or equal to the density threshold is used as a range formed by the third direction boundary line and the fourth direction boundary line. In other words, by analyzing the historical distribution density, it is determined that the interaction subject habitually ends drag operations in the second angle region, making it more convenient for the interaction subject to locate the end position of the drag operation within the range of the second region represented by second angle.

The third direction boundary line includes a straight line and a curved line, and the style of the third direction boundary line is not limited in this application. The fourth direction boundary line includes a straight line and a curved line, and the style of the fourth direction boundary line is not limited in this application.

In an exemplary implementation, the casting the virtual skill on the first virtual character when an end position of a drag operation on the aiming-type skill control is located in a first region of the touch layer includes: casting the virtual skill on the first virtual character when the end position of the drag operation on the aiming-type skill control is located in the first region of the touch layer, and a drag distance of the drag operation is greater than a first distance threshold, the first distance threshold being a distance threshold for determining whether to cancel skill casting.

As long as the end position of the drag operation is in the first region and the drag distance is greater than the first distance threshold, the operation of casting the virtual skill on the first virtual character is performed preferentially, improving the accuracy and clarity of casting the virtual skill on the first virtual character, thereby improving human-computer interaction efficiency.

The manner of determining whether to cancel skill casting based on the first distance threshold is applicable to the style where the second region is the second angle region on the touch layer as described in the above styles of the second region.

The method for determining the first distance threshold is not limited in this application, including but not limited to: determining the first distance threshold based on human experience; or using a radius of the wheel region as the first distance threshold; or customizing the first distance threshold based on interaction habits of the interaction subject.

The manner of determining whether to cancel skill casting based on the first distance threshold includes, but is not limited to: canceling skill casting if the drag distance of the drag operation is greater than or equal to the first distance threshold; and casting the virtual skill on another virtual character if the drag distance of the drag operation is less than the first distance threshold, the another virtual character being an object interacting with the first virtual character. For example, the another virtual character may include a virtual character in a same camp as the first virtual character, or may include a virtual character in a different camp from the first virtual character.

When the drag distance of the drag operation is greater than the first distance threshold, it may indicate that the drag operation has entered the second region, and in this case, if the end position of the drag operation on the aiming-type skill control is located in the first region on the touch layer, the operation of casting the virtual skill on the first virtual character is performed preferentially.

Detailed descriptions are provided below with reference to the two styles of the first region described above.

When the first region is a region with a regular shape, and the first region is provided within the second angle region, the virtual skill is cast on the first virtual character when the end position of the drag operation on the aiming-type skill control is located in the first region with the regular shape on the touch layer.

When the first region is the first angle region on the touch layer, and the first region has an intersection portion with the second region, the virtual skill is cast on the first virtual character when the end position of the drag operation on the aiming-type skill control is located in the intersection portion.

When the first region is the first angle region on the touch layer and the second region is the second angle region on the touch layer, the first angle region and the second angle region may share a region boundary line, or may not share a region boundary line. This is not limited in this application.

For example, a range with a historical distribution density greater than or equal to the density threshold is used as a range of the second angle. In other words, by analyzing the historical distribution density, it is determined that the interaction subject habitually ends drag operations in the second angle region, making it more convenient for the interaction subject to locate the end position of the drag operation within the range of the second region represented by second angle.

When the first region is the first angle region on the touch layer and the second region is the second angle region on the touch layer, this application does not limit a division manner between the first angle region and the second angle region on the touch layer. Examples of the division manner between the first angle region and the second angle region are described in detail below.

For example, a first angle corresponding to a first side that does not meet the interaction habit of the interaction subject is set as the first region, and a second angle corresponding to a second side that meets the interaction habit of the interaction subject is set as the second region. Not meeting the interaction habit of the interaction subject may be interpreted as follows: it is determined, based on the historical interaction data, that a distribution density of end positions of drag operations performed by the interaction subject is less than the density threshold. Meeting the interaction habit of the interaction subject may be interpreted as follows: it is determined, based on the historical interaction data, that a distribution density of end positions of drag operations performed by the interaction subject is greater than or equal to the density threshold. In other words, during interaction, a probability of the interaction subject canceling casting of the virtual skill is greater than a probability of casting the virtual skill on the first virtual character.

FIG. 9 is a schematic diagram of a first region and a second region. A circular wheel region 901 is equally divided in all directions. If a region within an angle a formed by a first direction boundary line A and a second direction boundary line B is used as the first region, the corresponding second region is obtained based on the region within an angle of 360-a. In this case, the directions to the right and upward relative to the aiming-type skill control, where the end positions of the drag operations of the interaction subject are more concentrated, are used as the direction for canceling skill casting, and the direction to the left relative to the aiming-type skill control, where the end positions of the drag operations of the interaction subject are less concentrated, is used as the direction for casting the virtual skill on the first virtual character.

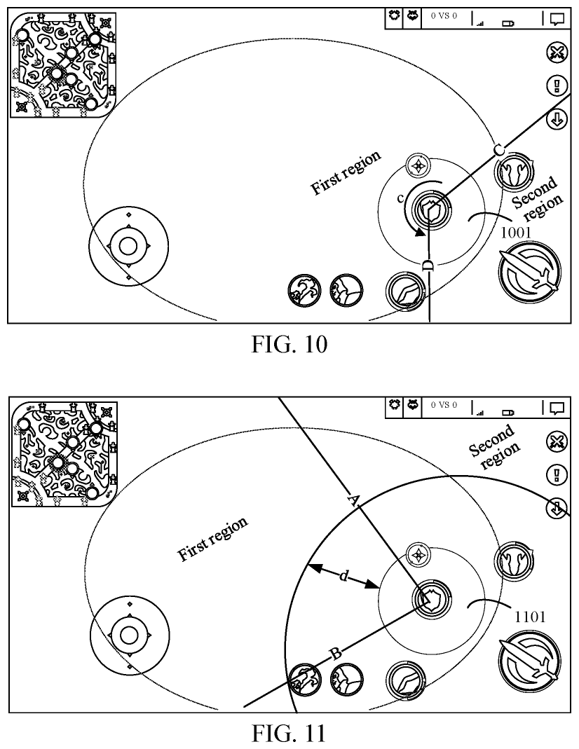

As shown in FIG. 10, a circular wheel region 1001 is equally divided in all directions. If a region within an angle c formed by a first direction boundary line C and a second direction boundary line D is defined as the first region, the corresponding second region is obtained based on the region within an angle of 360-c. In this case, the direction to the right relative to the aiming-type skill control, where the end positions of the drag operations of the interaction subject are more concentrated, is used as the direction for canceling skill casting, and the directions to the left and upward relative to the aiming-type skill control, where the end positions of the drag operations of the interaction subject are less concentrated, are used as the direction for casting the virtual skill on the first virtual character.

In conclusion, angular magnitudes of the first angle range of the first region and the second angle range of the second region are not limited in this application.

Next, another position of the first region on the touch layer is described.

In an exemplary implementation, the first region has no intersection with a third region, and the third region is a common landing region for the aiming-type skill control. The common landing region is determined based on landing positions of drag operations when the virtual skill is cast on virtual characters other than the first virtual character.

The first region avoids the third region, preventing the interaction subject from touching the first region by accident during the interaction of casting the virtual skill on other virtual characters, thereby improving the accuracy of triggering casting of the virtual skill on the first virtual character.

Other virtual characters are virtual characters in the three-dimensional virtual environment other than the first virtual character, including but not limited to non-player characters (NPCs) or virtual characters controlled by other interaction subjects. Such characters change over time, with the progression of interaction, and with actions of the interaction subject.

The third region may be a region in which a drag operation, performed by the interaction subject by operating the aiming-type skill control, ends to cast the virtual skill on another virtual character.

The common landing region may be a region formed by landing positions of drag operations during interaction when it is necessary to cast the virtual skill on other virtual characters.

The method for determining the common landing region based on landing positions of drag operations when the virtual skill is cast on other virtual characters includes: determining a distribution density for each of the landing positions of the drag operations when the virtual skill is cast on other virtual characters, and determining a region of landing positions whose landing densities are greater than a landing threshold as the common landing region.

There are a plurality of landing positions for drag operations when the virtual skill is cast on other virtual characters, and each landing position has a corresponding landing density. For example, for any one of the landing positions, the distribution density may be determined based on a quantity of drag operations ended at the landing position among a plurality of drag operations. The plurality of drag operations refer to all drag operations performed by the interaction subject when the virtual skill is cast on other virtual characters in a historical time period. The historical time period may be set based on experience, or may be flexibly adjusted based on application scenarios or requirements. This is not limited in this embodiment of this application.

For example, an implementation method for determining the distribution density of any landing position based on the quantity of drag operations ended at the landing position among the plurality of drag operations may be: using the quantity of drag operations ended at the landing position among the plurality of drag operations as the distribution density of the landing position. For example, an implementation method for determining the distribution density of any landing position based on the quantity of drag operations ended at the landing position among the plurality of drag operations may be: using a ratio of the quantity of drag operations ended at the landing position among the plurality of drag operations to a total quantity of the plurality of drag operations as the distribution density of the landing position.

After the distribution density corresponding to each of the plurality of landing positions is determined, a region of landing positions whose distribution densities are greater than the landing threshold among the plurality of landing positions is determined as the common landing region. The landing threshold may be set based on experience, or may be flexibly adjusted based on application scenarios or requirements. This is not limited in this embodiment of this application. For example, a region of landing positions whose distribution densities are greater than the landing threshold may be a smallest region among specific-shaped regions in which the landing positions with distribution densities greater than the landing threshold are located. The specific shape may include, but is not limited to, a circle, a rectangle, an ellipse, a trapezoid, and the like.

In an exemplary embodiment, the method for determining the common landing region based on landing positions of drag operations when the virtual skill is cast on other virtual characters further includes: determining, as the common landing region, a smallest region among specific-shaped regions that encompass all landing positions of drag operations when the virtual skill is cast on other virtual characters. In some embodiments, the specific shape is a circle, and the common landing region is a circular wheel region.

For example, when the common landing region is a wheel region, the process of ending a drag operation in the common landing region to cast the virtual skill on another virtual character is as follows: the interaction subject touches or presses a joystick portion to activate the wheel region of the aiming-type skill control, and performs a drag operation to select another virtual character to be attacked, the joystick portion being used for adjusting an aiming direction of the virtual skill. The interaction subject may push the joystick portion to a target direction to determine an aiming region. The system automatically calculates a casting angle and distance of the virtual skill, and the virtual skill is cast immediately after the joystick portion is released.

For example, the common landing region is a wheel region, and the first region is a region with a regular shape on the touch layer. In this case, the first region 701 has no intersection with the wheel region 702.

For example, the common landing region is a wheel region, and the first region is a first angle region on the touch layer. In this case, although the first region includes a left half portion of a wheel region 902, when the end position of the drag operation is in the left half portion of the wheel region 902, the virtual skill is preferentially cast on another virtual character; when the end position of the drag operation is outside the wheel region, it is considered by default that the end position of the drag operation is in the first region, and the virtual skill is cast on the first virtual character.

In an exemplary implementation, a distance between the first region and the third region is not less than a reference distance. In other words, the first region is a region at a reference distance outside the third region.

Setting the reference distance between the first region and the third region means that if a drag operation is ended within the reference distance outside the third region, the virtual skill cannot be cast on the first virtual character. This enhances the accuracy of determining whether the end position of the drag operation belongs to the first region, thereby improving the interaction efficiency of the interaction subject.

The method for determining the distance between the first region and the third region is not limited in this embodiment of this application. For example, a minimum value among distances between each position in the first region and each position in the third region is used as the distance between the first region and the third region. For example, a distance between a center point of the first region and a center point of the third region is used as the distance between the first region and the third region.

The reference distance is used for constraining a shortest distance separating the first region and the third region. The method for determining the reference distance is not limited in this application, including but not limited to: setting the reference distance based on human experience; or customizing the reference distance based on interaction habits of the interaction subject; or determining, based on a correspondence between virtual skills and distances, a reference distance corresponding to the virtual skill that currently needs to be cast on the first virtual character.

Referring to the schematic diagram of a reference distance between a wheel region and a first region shown in FIG. 11, based on the division manner between the first region and the second region in FIG. 9, FIG. 11 shows a reference distance d between the first region and a wheel region 1101.

When a reference distance exists between the first region and the third region, an implementation manner of ending the drag operation in the first region is as follows: after the drag operation is triggered, the joystick portion is dragged to an edge position of the wheel region, an animation of the joystick portion being dragged to the edge position of the wheel region is displayed on the touch layer, and then the drag operation is continued towards the first region. At this time, an animation of the joystick portion continuing to move towards the first region based on the drag operation may be displayed on the touch layer, or an animation of the joystick portion staying at the edge position in the wheel region may be displayed on the touch layer. Content of the displayed animation during the drag operation is not limited in this application.

Next, another position of the first region on the touch layer is described.

In an exemplary implementation, the first region is determined according to a distribution, in the three-dimensional virtual environment, of occurrence positions of other virtual characters in the three-dimensional virtual environment in historical interaction data, the other virtual characters being characters interacting with the first virtual character.

The first region is determined according to the occurrence positions of other virtual characters in the three-dimensional virtual environment. In arrangement of the first region on the touch layer, frequent occurrence positions of other virtual characters are taken into consideration, to make the arrangement of the first region more reasonable and reduce conflicts between the drag operation performed by the interaction subject and the frequent occurrence positions of other virtual characters. This improves the efficiency of casting the virtual skill on the first virtual character, thereby improving human-computer interaction efficiency.

For other virtual characters, refer to the foregoing related descriptions, and details are not described herein again.

The historical interaction data is a data set that records past interactions between the interaction subject and other virtual characters. The data set includes detailed information such as occurrence positions of other virtual characters, movement trajectories, and skill casting positions. The occurrence position of another virtual character may be a position at which the another virtual character is located when it first enters the three-dimensional virtual environment to participate in the interaction; or a position at which the another virtual character is located when it flashes into the three-dimensional virtual environment; an occurrence position of the another virtual character when it reappears in the three-dimensional virtual environment after a halftime break. The occurrence position of another virtual character is not limited in this application.

The distribution of positions in the three-dimensional virtual environment may be hot spot regions formed by frequent occurrence positions of other virtual characters in the three-dimensional virtual environment.

The method for determining the first region according to a distribution, in the three-dimensional virtual environment, of occurrence positions of other virtual characters in the three-dimensional virtual environment in historical interaction data includes, but is not limited to: determining a region with a position distribution density less than a distribution threshold as the first region. In other words, the first region is set in a region where other virtual characters do not frequently appear. This reduces the probability that the interaction subject accidentally touches another virtual character when ending a drag operation in the first region. The end position of the drag operation can be located in the first region more accurately.

For example, the three-dimensional virtual environment is divided into a plurality of regions, the position distribution density corresponding to each region is calculated, regions with position distribution densities less than the distribution threshold are determined among the plurality of regions, and the first region is determined based on the regions with the position distribution densities less than the distribution threshold. The distribution threshold may be set based on experience, or may be flexibly adjusted based on application scenarios or requirements. This is not limited in this embodiment of this application.

For example, for any region, the corresponding position distribution density is determined based on a quantity of occurrence positions of other virtual characters in the region. For example, for any region, the quantity of occurrence positions of other virtual characters in the region is used as the position distribution density corresponding to the region. For example, for any region, a ratio of the quantity of occurrence positions of other virtual characters in the region to a total quantity of occurrence positions of other virtual characters is used as the position distribution density corresponding to the region. In some embodiments, the occurrence positions of other virtual characters may be all occurrence positions of other virtual characters within a reference time period. The reference time period may be set based on experience, or may be flexibly adjusted based on requirements. This is not limited in this embodiment of this application.

For example, there may be one or more regions with the distribution densities less than the distribution threshold. If there is one region with the distribution density less than the distribution threshold, the region with the distribution density less than the distribution threshold is directly used as the first region. If there are a plurality of regions with the distribution densities less than the distribution threshold, any one of the plurality of regions with the distribution densities less than the distribution threshold may be used as the first region, or a region with the smallest distribution density among the plurality of regions with the distribution densities less than the distribution threshold may be used as the first region, or an aggregated region of the plurality of regions with the distribution densities less than the distribution threshold may be used as the first region.

The following describes the position of the first region in the three-dimensional virtual environment with reference to different styles of the first region.

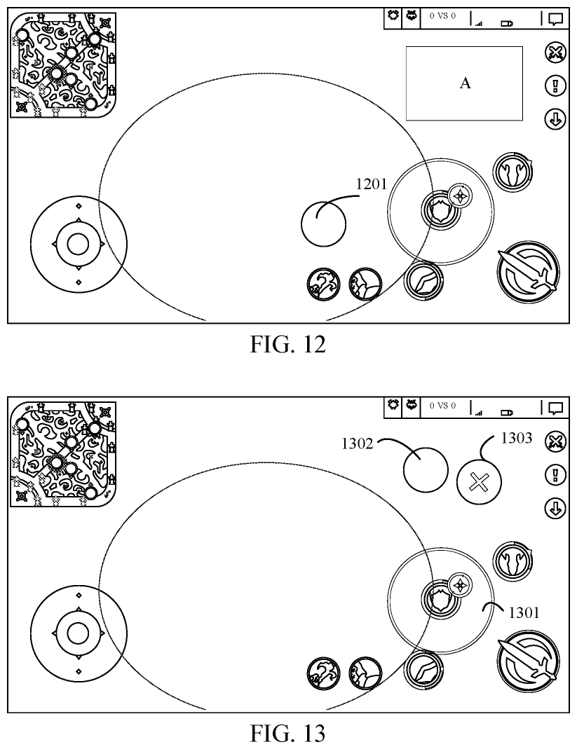

FIG. 12 is a schematic diagram of a first region based on FIG. 7 above. Since other virtual characters appear by default in region A at the upper right of the touch layer, a first region 1201 is set at the lower left of the touch layer.

When the first region is a region with a regular shape on the touch layer as described above, and the second region is also a region with a regular shape on the touch layer as described above, in an exemplary implementation, the first region and the second region are displayed on the touch layer in a direction of the aiming-type skill control relative to the touch layer. The direction of the aiming-type skill control relative to the touch layer may be interpreted as an orientation of a display position of the aiming-type skill control on the touch layer. For example, if the aiming-type skill control is displayed on the right side of the touch layer, the direction of the aiming-type skill control relative to the touch layer is the right side; if the aiming-type skill control is displayed on the left side of the touch layer, the direction of the aiming-type skill control relative to the touch layer is the left side. When the aiming-type skill control is displayed on the right side of the touch layer, the first region and the second region are also displayed on the right side of the touch layer, making it easier and closer for the interaction subject to reach the first region or the second region after completing the drag operation based on the aiming-type skill control. Furthermore, the positional directions of the first region and the second region on the touch layer are the same as the positional direction of the aiming-type skill control on the touch layer, so that the interaction subject does not need to change the operating hand to reach the first region or the second region based on the drag operation. When the interaction subject uses the right hand to operate the aiming-type skill control, the drag operation to the first region or the second region can be performed with the right hand.

When the aiming-type skill control is set at the lower right of the touch layer on the display interface, the interaction subject habitually uses the right thumb to operate the aiming-type skill control. Therefore, a more natural and comfortable interaction experience is to make all drag operations toward the right side of the touch layer. Therefore, setting the first region and the second region on the right side of the touch layer meets subjective design requirements.

When the first region is a region with a regular shape on the touch layer as described above, and the second region is also a region with a regular shape on the touch layer as described above, an area of the first region and an area of the second region are not limited in this application. The area of the first region may be smaller than the area of the second region; or the area of the first region may be larger than the area of the second region; or the area of the first region may be the same as the area of the second region.

FIG. 13 is a schematic diagram of a first region and a second region. An aiming-type skill control 1301 is located on the right side of a touch layer, and both a first region 1302 and a second region 1303 are located on the right side of the touch layer.

When the first region and the second region coexist on the touch layer, display styles of the first region and the second region are not limited in this application, including but not limited to: the first region is a region with a regular shape on the touch layer, and the second region is also a region with a regular shape on the touch layer; or the first region is a region with a regular shape on the touch layer, and the second region is a second angle region on the touch layer; or the first region is a first angle region on the touch layer, and the second region is a region with a regular shape on the touch layer; or the first region is a first angle region on the touch layer, and the second region is a second angle region on the touch layer.

In an exemplary implementation, the casting the virtual skill on the first virtual character when an end position of a drag operation on the aiming-type skill control is located in a first region of the touch layer includes: casting the virtual skill on the first virtual character when the end position of the drag operation on the aiming-type skill control is located in the first region of the touch layer, and an operation duration of the drag operation is less than a duration threshold.

Based on the preset duration threshold, the interaction subject needs to place the end position of the drag operation into the first region within the duration threshold, to cast the virtual skill on the first virtual character. This increases the fun of skill casting, thereby enhancing the interest of the interaction subject in interaction, and thus improving human-computer interaction efficiency.

The duration threshold is a maximum duration from the start to the end of a drag operation intended to cast the virtual skill on the first virtual character. When the operation duration of the drag operation is less than the duration threshold, the system considers by default that the interaction subject intends to cast the virtual skill on the first virtual character. Specifically, if the interaction subject completes the drag operation within the duration threshold, it is determined that the interaction subject clearly intends to cast the virtual skill on the first virtual character.

The method for setting the duration threshold is not limited in this application, including but not limited to: setting the duration threshold based on human experience; or determining, according to a correspondence between three-dimensional virtual environments and durations, a duration threshold corresponding to a current three-dimensional virtual environment; or customizing the duration threshold based on interaction habits of the interaction subject.

In an exemplary implementation, the method further includes: canceling casting of the virtual skill or casting the virtual skill on another virtual character when the end position of the drag operation on the aiming-type skill control is located in the first region of the touch layer, and the operation duration of the drag operation is greater than or equal to the duration threshold, the another virtual character being a character interacting with the first virtual character.

When the operation duration of the drag operation is greater than or equal to the duration threshold, it is possible that an unexpected event occurs during the interaction, preventing priority execution of casting the virtual skill on the first virtual character. This achieves rationalized and convenient control logic for skill casting, thereby enhancing interaction fun and improving human-computer interaction efficiency.

For the duration threshold, refer to the foregoing related descriptions, and details are not described herein again.

The operation duration of the drag operation being greater than or equal to the duration threshold may be interpreted as follows: during the execution of the drag operation, the interaction subject encounters an unexpected event and slows down the execution of the drag operation; or the interaction subject deliberately lingers at the end position of the drag operation for a longer time to make the operation duration greater than or equal to the duration threshold, thereby ensuring that even if the end position of the drag operation is in the first region, the virtual skill is no longer cast on the first virtual character.

Canceling casting of the virtual skill may be interpreted as follows: during the drag operation, the interaction subject discovers interaction content with a higher priority than casting the virtual skill on the first virtual character, and therefore cancels casting of the virtual skill. Casting the virtual skill on another virtual character may be interpreted as follows: during the drag operation of the interaction subject, another virtual character that the interaction subject intends to attack appears in a region of the three-dimensional virtual environment corresponding to the first region on the touch layer, and the interaction subject needs to cast the virtual skill on the another virtual character to obtain a greater beneficial effect compared to casting the virtual skill on the first virtual character; therefore, the interaction subject switches from casting the virtual skill on the first virtual character to casting the virtual skill on the another virtual character.

The following describes the process of casting the virtual skill on the first virtual character.

In an exemplary implementation, the virtual skill is cast toward a current position of the first virtual character in the three-dimensional virtual environment. The current position is a position of the first virtual character in the three-dimensional virtual environment upon completion of the drag operation. Based on this, casting the virtual skill immediately after the drag operation ends is beneficial for improving the efficiency of skill casting. Furthermore, the virtual skill can be cast without complex logic, requiring less computation.

Upon completion of the drag operation, the current position of the first virtual character in the three-dimensional virtual environment is determined. The process of casting the virtual skill on the first virtual character is casting the virtual skill toward the current position of the first virtual character by default.

The current position may be a foot position of the first virtual character in the three-dimensional virtual environment when the drag operation ends; or a head position of the first virtual character in the three-dimensional virtual environment when the drag operation ends. This application does not limit the definition of the current position of the first virtual character.

In an exemplary implementation, the casting the virtual skill on the first virtual character includes: casting the virtual skill toward a reference position of the first virtual character in the three-dimensional virtual environment. The reference position is a position of the first virtual character in the three-dimensional virtual environment after a buffer duration elapses upon completion of the drag operation. The buffer duration is a duration in which the virtual skill is buffered from a first state to a second state. The first state is a triggered state of the virtual skill upon completion of the drag operation. The second state is a cast state of the virtual skill.

Considering that there may be a buffer duration from triggering to casting of the virtual skill, and during the buffer duration, the first virtual character may be moving continuously in the three-dimensional virtual environment, the virtual skill is cast toward the reference position of the first virtual character. This improves the accuracy of skill casting, thereby enhancing the interaction experience of the interaction subject and thus improving human-computer interaction efficiency.

The buffer duration may be a delay duration between the first state, i.e., triggered state, and the second state, i.e., cast state, of the virtual skill. When the interaction subject triggers the virtual skill, the virtual skill first undergoes an “input recognition” phase. A game engine in a terminal device needs to recognize the input triggering the virtual skill, and confirm that this is effective skill triggering. This process may include input filtering to prevent continuous skill casting caused by rapid consecutive inputs, which could affect game balance. After confirming the skill trigger, the terminal device packages the skill trigger instruction into a data packet that is ready to be transmitted to the server. During the transmission of the data packet from the terminal device to the server, network delay occurs. The network delay is determined by a plurality of factors such as a physical distance between the terminal device of the interaction subject and the server, network conditions, and server processing capacity. After receiving the virtual skill trigger instruction, the server performs a series of logical processes, including checking skill cooldown status, resource consumption (such as mana points and energy points) of the player, validity of a skill target, and the like. The series of logical processes ensures the fairness of the game and the rationality of skill casting.

When the first virtual character moves in the three-dimensional virtual environment in real time, after the buffer duration, the virtual skill is cast toward the position of the first virtual character in the three-dimensional virtual environment, so that the virtual skill can accurately act on the first virtual character, avoiding deviation in casting the virtual skill on the first virtual character due to the movement of the first virtual character during the buffer duration.

After the virtual skill is cast on the first virtual character when the end position of the drag operation is located in the first region of the touch layer, the following describes another manner of casting the virtual skill on the first virtual character.

In an exemplary implementation, the method further includes: casting the virtual skill on the first virtual character when the end position of the drag operation on the aiming-type skill control is located in a fourth region of the three-dimensional virtual environment. The fourth region is a region centered on the first virtual character in a horizontal plane of the three-dimensional virtual environment.

The drag operation on the aiming-type skill control on the touch layer is combined with the fourth region in the three-dimensional virtual environment. When the end position of the drag operation on the touch layer corresponds to a position located in the fourth region of the three-dimensional virtual environment, casting the virtual skill on the first virtual character is completed. By providing the fourth region in the three-dimensional virtual environment and directly casting the virtual skill to the fourth region already positioned at the feet of the first virtual character through the drag operation on the touch layer, the precision of casting the virtual skill is improved.

The fourth region is a region, centered on the current position of the first virtual character, formed in the three-dimensional virtual environment. The shape of the fourth region is not limited in this application, including but not limited to: an ellipse centered on the position of the first virtual character; or a rectangle centered on the position of the first virtual character. A method for determining a size of the fourth region is not limited in this application, including but not limited to: determining the size of the fourth region based on human experience; or determining the fourth region corresponding to the first virtual character based on a correspondence between virtual characters and regions; or determining, based on a correspondence between virtual skills and regions, the fourth region corresponding to the virtual skill currently to be cast; or customizing the size of the fourth region based on interaction habits of the interaction subject.

A display manner of the fourth region is not limited in this application, including but not limited to the manner described below. In an exemplary implementation, the method further includes: displaying the fourth region in the horizontal plane of the three-dimensional virtual environment when the drag distance of the drag operation on the aiming-type skill control is greater than the second distance threshold. The second distance threshold is a distance threshold for determining whether a current operation is the drag operation or a tap operation.

When it is determined that triggering the aiming-type skill control results in a drag operation, the fourth region is displayed in the three-dimensional virtual environment, saving computing resources when no drag operation occurs, thereby improving interaction efficiency.

For the second distance threshold, the drag operation, and the tap operation, refer to the foregoing related descriptions. Details are not described herein again.

If the drag distance of the drag operation on the aiming-type skill control is greater than the second distance threshold, it may be determined that the intended trigger is a drag operation, not a tap operation.

When it is determined that a drag operation occurs, the fourth region is displayed in the three-dimensional virtual environment. A display effect of the fourth region in the three-dimensional virtual environment includes, but is not limited to: moving along with the movement of the first virtual character in the three-dimensional virtual environment.

The end position of the drag operation being located in the fourth region of the three-dimensional virtual environment may be interpreted as follows: the fourth region in the three-dimensional virtual environment is converted to the first region of the touch layer, and it is determined whether the end position of the drag operation occurring on the touch layer is within the first region formed by conversion. If the end position is within the first region formed by conversion, it proves that the end position of the drag operation is located in the fourth region of the three-dimensional virtual environment.

The method for converting the fourth region in the three-dimensional virtual environment into the first region on the touch layer is not limited in this application. In an exemplary implementation, regional position coordinates corresponding to the fourth region are converted into regional position coordinates corresponding to the first region on the touch layer by using a mapping matrix. However, in this case, the first region obtained after mapping is not displayed on the touch layer. When performing a drag operation on the touch layer, the interaction subject simply drags toward the observed fourth region in the three-dimensional virtual environment.

If the end position of the drag operation on a two-dimensional plane of the touch layer falls within the first region converted from the fourth region by using the mapping matrix, it proves that the end position is within the fourth region, and the virtual skill is cast on the first virtual character.

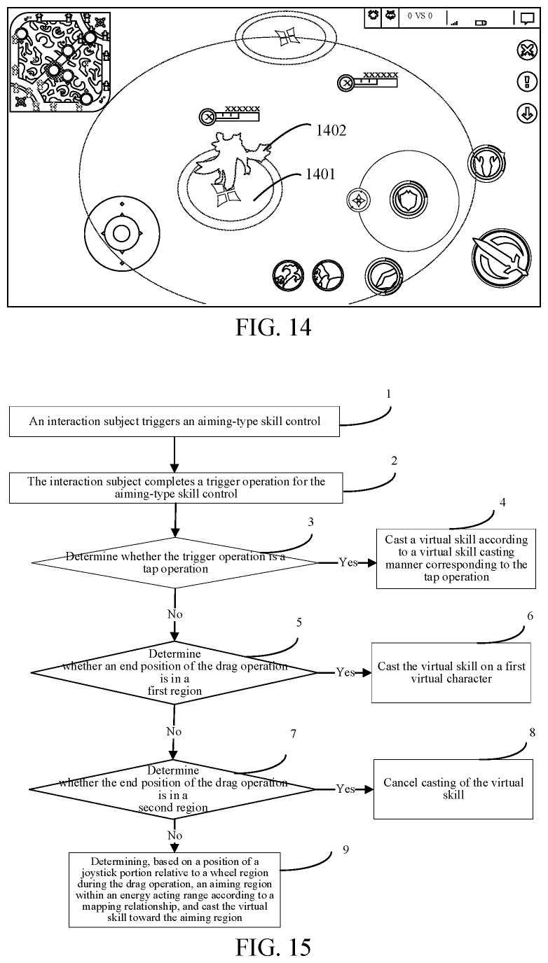

FIG. 14 is a schematic diagram of a fourth region. A fourth region 1401 centered on a first virtual character 1402 is displayed in a three-dimensional virtual environment. The fourth region 1401 is not a same type of region as the aiming region 604 shown in FIG. 6.
Operation 503: Display, in the three-dimensional virtual environment, a skill effect of the virtual skill on the first virtual character.

When the virtual skill is cast, the terminal device first detects and confirms the operation. Once the virtual skill is cast, the game engine immediately initiates skill effects related to the virtual skill acting on the first virtual character. These skill effects include not only an action animation of the virtual skill being cast on the first virtual character, but also a reaction animation of the first virtual character after experiencing the virtual skill, and even interactive changes in the surrounding environment, to enhance the visual impact and immersive feeling of the skill effects. A display style and effect content of the skill effect are not limited in this application, provided that the interaction subject can perceive the influence of the virtual skill on the first virtual character.

In this application, the first region dedicated to casting the virtual skill on the first virtual character is arranged on the touch layer, so that the interaction subject can accurately cast the virtual skill on the first virtual character simply by controlling the end position of the drag operation to fall in the first region, thereby improving the accuracy and efficiency of casting the virtual skill on the first virtual character. In addition, since the drag operation can be ended by stopping the touch, in this application, the virtual skill can be accurately cast on the first virtual character by performing a drag operation in the touch layer and stopping the touch in the first region of the touch layer. The interaction subject can cast the virtual skill on the first virtual character without complex interaction operations, thereby reducing the cost of learning interaction operations, improving the usability of interaction, and improving the human-computer interaction efficiency.

Referring to FIG. 15, FIG. 15 is an overall flowchart of a method for virtual character skill casting.
Operation 1: An interaction subject triggers an aiming-type skill control.

For the aiming-type skill control, refer to related descriptions in operation 501, and details are not described herein again.
Operation 2: The interaction subject completes a trigger operation on the aiming-type skill control.
Operation 3: Determine whether the trigger operation is a tap operation, perform operation 4 if the trigger operation is a tap operation, and perform operation 5 if the trigger operation is not a tap operation (i.e., the trigger operation is a drag operation).
Operation 4: Cast a virtual skill according to a virtual skill casting manner corresponding to the tap operation.
Operation 5: Determine whether an end position of the drag operation is in a first region, perform operation 6 if the end position of the drag operation is in the first region, and perform operation 7 if the end position of the drag operation is not in the first region.

For the first region, refer to related descriptions in operation 501 and operation 502, and details are not described herein again.
Operation 6: Cast the virtual skill on a first virtual character.
Operation 7: Determine whether the end position of the drag operation is in a second region, perform operation 8 if the end position of the drag operation is in the second region, and perform operation 9 if the end position of the drag operation is not in the second region.

For the second region, refer to related descriptions in operation 502, and details are not described herein again.
Operation 8: Cancel casting of the virtual skill.
Operation 9: Determine, based on a position of a joystick portion relative to a wheel region during the drag operation, an aiming region within an energy acting range according to a mapping relationship, and cast the virtual skill toward the aiming region.

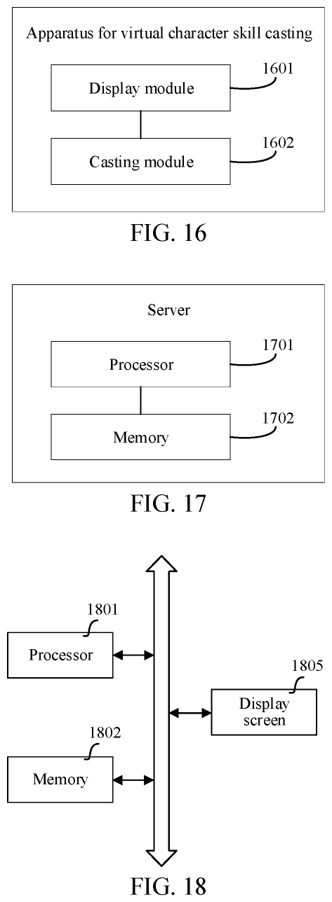

Referring to FIG. 16, an embodiment of this application provides an apparatus for virtual character skill casting. The apparatus includes:
a display module 1601, configured to display a first virtual character located in a three-dimensional virtual environment and an aiming-type skill control located on a touch layer, the aiming-type skill control being configured to cast, after being triggered, a virtual skill of the first virtual character toward an aiming region; and
a casting module 1602, configured to cast the virtual skill on the first virtual character when an end position of a drag operation on the aiming-type skill control is located in a first region of the touch layer.

The display module 1601 is further configured to display, in the three-dimensional virtual environment, a skill effect of the virtual skill on the first virtual character.

A plane in which the touch layer is located is different from a horizontal plane in the three-dimensional virtual environment.

In an implementation, the first region is a region with a regular shape on the touch layer.

In an implementation, the first region is a first angle region on the touch layer, and a vertex of the first angle region is determined based on the aiming-type skill control.

In an implementation, the first region has no intersection with the second region, and the second region is a region on the touch layer for canceling skill casting.

In an implementation, the first region has no intersection with a third region, and the third region is a common landing region for the aiming-type skill control. The common landing region is determined based on landing positions of drag operations when the virtual skill is cast on virtual characters other than the first virtual character.

In an implementation, the apparatus further includes:
a determining module, configured to determine a distribution density for each of the landing positions; and determine a region of landing positions whose distribution densities are greater than a landing threshold as the common landing region.

In an implementation, a distance between the first region and the third region is not less than a reference distance.

In an implementation, the casting module 1602 is configured to: cast the virtual skill on the first virtual character when the end position of the drag operation on the aiming-type skill control is located in the first region of the touch layer, and a drag distance of the drag operation is greater than a first distance threshold. The first distance threshold is a distance threshold for determining whether to cancel skill casting.

In an implementation, the casting module 1602 is configured to: cast the virtual skill on the first virtual character when the end position of the drag operation on the aiming-type skill control is located in the first region of the touch layer, and a drag distance of the drag operation is greater than a second distance threshold. The second distance threshold is a distance threshold for determining whether a current operation is the drag operation or a tap operation.

In an implementation, the casting module 1602 is further configured to: cast the virtual skill on the first virtual character when the end position of the drag operation on the aiming-type skill control is located in a fourth region of the three-dimensional virtual environment. The fourth region is a region centered on the first virtual character in a horizontal plane of the three-dimensional virtual environment.

In an implementation, the casting module 1602 is further configured to: display the fourth region in the horizontal plane of the three-dimensional virtual environment when the drag distance of the drag operation on the aiming-type skill control is greater than a second distance threshold. The second distance threshold is a distance threshold for determining whether a current operation is the drag operation or a tap operation.

In an implementation, the casting module 1602 is configured to: cast the virtual skill on the first virtual character when the end position of the drag operation on the aiming-type skill control is located in the first region of the touch layer, and an operation duration of the drag operation is less than a duration threshold.

In an implementation, the casting module 1602 is further configured to: cancel casting of the virtual skill or casting the virtual skill on another virtual character when the end position of the drag operation on the aiming-type skill control is located in the first region of the touch layer, and the operation duration of the drag operation is greater than or equal to the duration threshold, the another virtual character being a character interacting with the first virtual character.

In an implementation, the first region is determined according to a distribution, in the three-dimensional virtual environment, of occurrence positions of other virtual characters in the three-dimensional virtual environment in historical interaction data, the other virtual characters being characters interacting with the first virtual character.

In an implementation, the casting module 1602 is configured to cast the virtual skill toward a reference position of the first virtual character in the three-dimensional virtual environment. The reference position is a position of the first virtual character in the three-dimensional virtual environment after a buffer duration elapses upon completion of the drag operation. The buffer duration is a duration in which the virtual skill is buffered from a first state to a second state. The first state is a triggered state of the virtual skill upon completion of the drag operation. The second state is a cast state of the virtual skill.

In an implementation, the casting module 1602 is configured to cast a virtual skill toward a current position of the first virtual character in the three-dimensional virtual environment. The current position is a position of the first virtual character in the three-dimensional virtual environment upon completion of the drag operation.

The above functional modules are only described for exemplary purposes when the apparatus provided above implements functions of the apparatus. In actual applications, the functions may be allocated to different functional modules according to specific needs, which means that the internal structure of the apparatus is divided to different functional modules to complete all or some of the above described functions. In addition, the apparatus and method embodiments provided in the foregoing embodiments belong to a same concept. For a specific implementation process and a beneficial effect thereof, refer to the method embodiments, and details are not described herein again.

In an exemplary embodiment, a computer device is further provided. The computer device includes a processor and a memory, and the memory has at least one computer program stored therein. The at least one computer program is loaded and executed by one or more processors, so that the computer device implements any one of the foregoing methods for virtual character skill casting. The computer device may be a server, or may be a terminal device. Next, structures of the server and the terminal device are separately described.

FIG. 17 is a schematic structural diagram of a server according to an embodiment of this application. The server may vary due to different configurations or performance, and may include one or more central processing units (CPUs) 1701 and one or more memories 1702. The one or more memories 1702 store at least one computer program. The at least one computer program is loaded and executed by the one or more CPUs 1701, so that the server implements the method for virtual character skill casting according to the foregoing method embodiments. Certainly, the server may further have components such as a wired or wireless network interface, a keyboard, and an input/output interface, so as to perform input/output. The server may further include other components configured to implement functions of the device. Details are not described herein.

FIG. 18 is a schematic structural diagram of a terminal device according to an embodiment of this application. The terminal device may be: a PC, a mobile phone, a smartphone, a PDA, a wearable device, a handheld portable game device, a PPC, a tablet computer, a notebook computer, a desktop computer, a smart on-board unit, a smart television, a smart speaker, a smartwatch, or an in-vehicle terminal. The terminal device may alternatively be referred to as a user equipment, a portable terminal device, a laptop terminal device, a desktop terminal device, or the like.

The terminal device includes a processor 1801 and a memory 1802.

The processor 1801 may include one or more processing cores, for example, a 4-core processor or an 8-core processor. The processor 1801 may be implemented by using at least one hardware form of digital signal processing (DSP), a field-programmable gate array (FPGA), or a programmable logic array (PLA). The processor 1801 may also include a main processor and a co-processor. The main processor is a processor configured to process data in an awake state, and is also referred to as a CPU. The co-processor is a low-power processor configured to process data in a standby state. In some embodiments, the processor 1801 may be integrated with a graphics processing unit (GPU), and the GPU is configured to be responsible for rendering and drawing content that needs to be displayed on a display screen. In some embodiments, the processor 1801 may further include an artificial intelligence (AI) processor. The AI processor is configured to process computing operations related to machine learning.

The memory 1802 may include one or more computer-readable storage media, and the computer-readable storage media may be non-transitory. The memory 1802 may further include a high-speed random access memory (RAM), and a non-volatile memory such as one or more magnetic disk storage devices and flash storage devices. In some embodiments, the non-transitory computer-readable storage medium in the memory 1802 is configured to store at least one instruction. The at least one instruction is executed by the processor 1801, so that the terminal device implements the method for virtual character skill casting according to the method embodiments of this application. In some embodiments, the non-transitory computer-readable storage medium may also be referred to as a non-volatile computer-readable storage medium.

In some embodiments, the terminal device may further include a display screen 1805.

The display screen 1805 is configured to display a user interface (UI). The UI may include a graph, a text, an icon, a video, or any combination thereof. When the display screen 1805 is a touch display screen, the display screen 1805 is further capable of collecting a touch signal on or above a surface of the display screen 1805. The touch signal may be inputted to the processor 1801 as a control signal for processing. In this case, the display screen 1805 may further be configured to provide a virtual button and/or a virtual keyboard, also referred to as a soft button and/or a soft keyboard. In some embodiments, there may be one display screen 1805, disposed on a front panel of the terminal device. In some other embodiments, there may be at least two display screens 1805 that are separately disposed on different surfaces of the terminal device or in a folded design. In some other embodiments, the display screen 1805 may be a flexible display screen, and is disposed on a curved surface or a folded surface of the terminal device. Even, the display screen 1805 may be set in a non-rectangular irregular shape, i.e., a special-shaped screen. The display 1805 may be made of materials such as a liquid crystal display (LCD), or an organic light-emitting diode (OLED). In some embodiments, the first virtual character, the aiming-type skill control, and the like involved in the method embodiments of this application are displayed by using the display screen 1805.

A person skilled in the art may understand that the structure shown in FIG. 18 does not constitute a limitation to the terminal device, and the terminal device may include more or fewer components than those shown in the figure, or some components may be combined, or a different component deployment may be used.

In an exemplary embodiment, a non-volatile computer-readable storage medium is further provided. The non-volatile computer-readable storage medium stores at least one computer program, and the at least one computer program is loaded and executed by a processor, so that a computer implements any one of the foregoing methods for virtual character skill casting.

In an implementation, the foregoing non-volatile computer-readable storage medium may be a read-only memory (ROM), a RAM, a compact disc read-only memory (CD-ROM), a magnetic tape, a floppy disk, an optical data storage device, or the like.

In an exemplary embodiment, a computer program product or a computer program is further provided. The computer program product or the computer program includes computer instructions, and the computer instructions are loaded and executed by a processor, so that a computer implements any one of the foregoing methods for virtual character skill casting.

Information (including, but not limited to, user equipment information, user personal information, and the like), data (including, but not limited to, data for analysis, stored data, displayed data, and the like), and signals involved in this application are authorized by a user or are fully authorized by all parties, and collection, use, and processing of related data need to comply with related laws and regulations and standards of related countries and regions. For example, the historical interaction data involved in this application is obtained under sufficient authorization.

The term “a plurality of” mentioned in this specification means two or more. The term “and/or” describes an association relationship between associated objects and indicates that three relationships may exist. For example, A and/or B may indicate the following three cases: Only A exists, both A and B exist, and only B exists. The character “/” indicates an “or” relationship between associated objects.

The foregoing descriptions are merely exemplary embodiments of this application, but are not intended to limit this application. Any modification, equivalent replacement, or improvement made within the principle of this application shall fall within the protection scope of this application.

What is claimed is:

1. A method for controlling a virtual character to cast a virtual skill performed by a computer device, the method comprising:
displaying a graphical user interface including a first virtual character located in a three-dimensional virtual environment and an aiming-type skill control located on a touch layer of the graphical user interface, wherein a plane in which the touch layer is located is different from a horizontal plane in the three-dimensional virtual environment;
detecting a drag operation on the aiming-type skill control;
when an end position of the drag operation on the aiming-type skill control is located in a first region of the touch layer, casting the virtual skill on the first virtual character; and
displaying, on the graphical user interface, a skill effect of the virtual skill on the first virtual character in the three-dimensional virtual environment.

2. The method according to claim 1, wherein the first region is a first angle region on the touch layer, and a vertex of the first angle region is determined based on the aiming-type skill control.

3. The method according to claim 1, wherein the first region has no intersection with a second region, and the second region is a region on the touch layer for canceling skill casting.

4. The method according to claim 1, wherein the first region has no intersection with a third region, the third region is a common landing region for the aiming-type skill control based on landing positions of drag operations when the virtual skill is cast on virtual characters other than the first virtual character.

5. The method according to claim 4, further comprising:
determining a distribution density for each of the landing positions; and
determining a region of landing positions whose distribution densities are greater than a landing threshold as the common landing region.

6. The method according to claim 4, wherein a distance between the first region and the third region is not less than a reference distance.

7. The method according to claim 1, wherein the casting the virtual skill on the first virtual character when comprises:
casting the virtual skill on the first virtual character when a drag distance of the drag operation is greater than a first distance threshold,
the first distance threshold being a distance threshold for determining whether to cancel skill casting.

8. The method according to claim 1, wherein the casting the virtual skill on the first virtual character when comprises:
casting the virtual skill on the first virtual character when a drag distance of the drag operation is greater than a second distance threshold;
the second distance threshold being a distance threshold for determining whether a current operation is the drag operation or a tap operation.

9. The method according to claim 1, wherein the casting the virtual skill on the first virtual character comprises:
casting the virtual skill on the first virtual character when the end position of the drag operation on the aiming-type skill control is located in a fourth region of the three-dimensional virtual environment,
the fourth region being a region centered on the first virtual character in a horizontal plane of the three-dimensional virtual environment.

10. The method according to claim 1, wherein the casting the virtual skill on the first virtual character comprises:
casting the virtual skill on the first virtual character when the end position of the drag operation on the aiming-type skill control is located in the first region of the touch layer, and an operation duration of the drag operation is less than a duration threshold.

11. The method according to claim 1, further comprising:
canceling casting of the virtual skill or casting the virtual skill on another virtual character when the end position of the drag operation on the aiming-type skill control is located in the first region of the touch layer, and the operation duration of the drag operation is greater than or equal to a duration threshold, the another virtual character being a character interacting with the first virtual character.

12. The method according to claim 1, wherein the casting the virtual skill on the first virtual character comprises:
casting the virtual skill toward a reference position of the first virtual character in the three-dimensional virtual environment,
the reference position being a position of the first virtual character in the three-dimensional virtual environment after a buffer duration elapses upon completion of the drag operation, the buffer duration being a duration in which the virtual skill is buffered from a first state to a second state, the first state being a triggered state of the virtual skill upon completion of the drag operation, and the second state being a cast state of the virtual skill.

13. The method according to claim 1, wherein the casting the virtual skill on the first virtual character comprises:
casting the virtual skill toward a current position of the first virtual character in the three-dimensional virtual environment;
the current position being a position of the first virtual character in the three-dimensional virtual environment upon completion of the drag operation.

14. A computer device, comprising a processor and a memory, the memory storing at least one computer program, and the at least one computer program, when executed by the processor, causing the computer device to implement a method for controlling a virtual character to cast a virtual skill including:
displaying a graphical user interface including a first virtual character located in a three-dimensional virtual environment and an aiming-type skill control located on a touch layer of the graphical user interface, wherein a plane in which the touch layer is located is different from a horizontal plane in the three-dimensional virtual environment;
detecting a drag operation on the aiming-type skill control;
when an end position of the drag operation on the aiming-type skill control is located in a first region of the touch layer, casting the virtual skill on the first virtual character; and
displaying, on the graphical user interface, a skill effect of the virtual skill on the first virtual character in the three-dimensional virtual environment.

15. The computer device according to claim 14, wherein the casting the virtual skill on the first virtual character when comprises:
casting the virtual skill on the first virtual character when a drag distance of the drag operation is greater than a first distance threshold,
the first distance threshold being a distance threshold for determining whether to cancel skill casting.

16. The computer device according to claim 14, wherein the casting the virtual skill on the first virtual character when comprises:
casting the virtual skill on the first virtual character when a drag distance of the drag operation is greater than a second distance threshold;
the second distance threshold being a distance threshold for determining whether a current operation is the drag operation or a tap operation.

17. The computer device according to claim 14, wherein the casting the virtual skill on the first virtual character comprises:
casting the virtual skill on the first virtual character when the end position of the drag operation on the aiming-type skill control is located in a fourth region of the three-dimensional virtual environment,
the fourth region being a region centered on the first virtual character in a horizontal plane of the three-dimensional virtual environment.

18. The computer device according to claim 14, wherein the casting the virtual skill on the first virtual character comprises:
casting the virtual skill on the first virtual character when the end position of the drag operation on the aiming-type skill control is located in the first region of the touch layer, and an operation duration of the drag operation is less than a duration threshold.

19. The computer device according to claim 14, wherein the casting the virtual skill on the first virtual character comprises:
casting the virtual skill toward a reference position of the first virtual character in the three-dimensional virtual environment,
the reference position being a position of the first virtual character in the three-dimensional virtual environment after a buffer duration elapses upon completion of the drag operation, the buffer duration being a duration in which the virtual skill is buffered from a first state to a second state, the first state being a triggered state of the virtual skill upon completion of the drag operation, and the second state being a cast state of the virtual skill.

20. A non-transitory computer-readable storage medium storing at least one computer program therein, and the at least one computer program, when loaded and executed by a processor of a computer device, causing the computer device to implement a method for controlling a virtual character to cast a virtual skill including:
displaying a graphical user interface including a first virtual character located in a three-dimensional virtual environment and an aiming-type skill control located on a touch layer of the graphical user interface, wherein a plane in which the touch layer is located is different from a horizontal plane in the three-dimensional virtual environment;
detecting a drag operation on the aiming-type skill control;
when an end position of the drag operation on the aiming-type skill control is located in a first region of the touch layer, casting the virtual skill on the first virtual character; and
displaying, on the graphical user interface, a skill effect of the virtual skill on the first virtual character in the three-dimensional virtual environment.
